(19) United States
(12) Patent Application Publication
(10) Pub. No.: US 2011/0007289 A1
(43) Pub. Date: Jan. 13, 2011

(54) DEVICE CONSTRUCTED AND ARRANGED TO GENERATE RADIATION, LITHOGRAPHIC APPARATUS, AND DEVICE MANUFACTURING METHOD

(76) Inventors: Maarten Marinus Johannes Wilhelmus Van Herpen, Heesch (NL); Wouter Anthon Soer, Nijmegen (NL)

Correspondence Address: PILLSBURY WINTHROP SHAW PITTMAN, LLP, P.O. BOX 10500, MCLEAN, VA, 22102, US

(21) Appl. No.: 12/920,065

(22) PCT Filed: Feb. 23, 2009
(86) PCT No.: PCT/NL2009/050082

§ 371 Date: Aug. 27, 2010

Related U.S. Application Data
(60) Provisional application No. 61/064,338, filed on Feb. 28, 2008.

(51) Int. Cl. G03B 27/52; H05H 1/24

(52) U.S. Cl. 355/30; 355/77; 315/111.21

(57) ABSTRACT

A device is constructed and arranged to generate radiation by using an electrical discharge through a gaseous medium. The device includes a first electrode and a second electrode, and a liquid supply arranged to provide a liquid to a location in the device. The device is arranged to be electrically supplied with a voltage and to supply the voltage at least partially to the first electrode and the second electrode in order to allow the electrical discharge to be generated in an electrical field created by the voltage. The electrical discharge produces a radiating plasma. The device also includes a shield arranged between the discharge location and a conducting part connected to the first electrode and/or the second electrode.

### CROSS-REFERENCE TO RELATED APPLICATIONS

This application claims the benefit of U.S. provisional application 61/064 338, which was filed on Feb. 28, 2008, and which is incorporated herein in its entirety by reference.

### FIELD

The present invention relates to a device constructed and arranged to generate radiation, a lithographic apparatus comprising such a device, and a device manufacturing method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, such as a mask, may be used to generate a circuit pattern corresponding to an individual layer of the IC, and this pattern can be imaged onto a target portion (e.g. including part of one or several dies) on a substrate (e.g. a silicon wafer) that has a layer of radiation-sensitive material (resist). In general, a single substrate will contain a network of adjacent target portions that are successively exposed. Known lithographic apparatus include steppers, in which each target portion is irradiated by exposing an entire pattern onto the target portion at once, and scanners, in which each target portion is irradiated by scanning the pattern through the projection beam in a given direction (the “scanning” direction) while synchronously scanning the substrate parallel or anti-parallel to this direction. In a lithographic apparatus as described above a device for generating radiation or radiation source will be present.

In a lithographic apparatus, the size of features that can be imaged onto a substrate may be limited by the wavelength of the projection radiation. To produce integrated circuits with a higher density of devices, and hence higher operating speeds, it is desirable to be able to image smaller features. While most current lithographic projection apparatus employ ultraviolet light generated by mercury lamps or excimer lasers, it has been proposed to use shorter wavelength radiation of around 13 nm. Such radiation is termed extreme ultraviolet, also referred to as XUV or EUV, radiation. The abbreviation ‘XUV’ generally refers to the wavelength range from several tenths of a nanometer to several tens of nanometers, combining the soft x-ray and vacuum UV range, whereas the term ‘EUV’ is normally used in conjunction with lithography (EUVL) and refers to a radiation band from approximately 5 to 20 nm, i.e. part of the XUV range.

A discharge produced (DPP) source generates plasma by a discharge in a substance, for example a gas or vapor, between an anode and a cathode, and may subsequently create a high-temperature discharge plasma by Ohmic heating caused by a pulsed current flowing through the plasma. In this case, the desired radiation is emitted by the high-temperature discharge plasma. During operation, the EUV radiation is generated by creating a pinch.

Generally, a plasma is formed by a collection of free-moving electrons and ions (atoms that have lost electrons). The energy needed to strip electrons from the atoms to make plasma can be of various origins: thermal, electrical, or light (ultraviolet light or intense visible light from a laser). More details on the pinch, the laser triggering effect and its application in a source with rotating electrodes may be found in J. Pankert, G. Derra, P. Zink, Status of Philips' extreme-UV source, SPIE Proc. 6151-25 (2006) (hereinafter “Pankert et al.”).

A known practical EUV source comprises a pair of rotating disk shaped electrodes that are partly immersed in a respective liquid bath. The electrodes are rotated so that liquid from the liquid baths is carried along their surface. An ignition source is configured to trigger a discharge produced radiating plasma from liquid adherent to the electrode, by a discharge at a location between the first electrode and the second electrode.

Typically, one electrode is at ground potential while the other one is at high voltage. The electrode gap may be relatively small, e.g. of the order of 3 mm. Also it is desired to keep the enclosed area and thus the self-induction of the discharge circuit as small as possible (typically<15 nH). Consequently, in most designs the part of the discharge circuit that is at high voltage is relatively close to the part that is at ground potential. During operation of the source, the substance used as the liquid (e.g. tin) is evaporated by the trigger laser and the electrical discharge causes an emission of debris. Due to the high temperatures, usually above the melting point of the substance, the evaporated and emitted substance easily forms large droplets between the electrodes and conducting parts connected therewith. These droplets frequently short-circuit the conducting parts and thus may result in failure of the source.

### SUMMARY

It is desirable to reduce the occurrence of short-circuits. According to an aspect, there is provided a device that is constructed and arranged to generate radiation. The device comprises a shield that is arranged between the discharge location and at least a conducting part connected to at least one of the electrodes.

Instead of a liquid bath, the device for generating radiation may comprise an alternative liquid supply such as a droplet injector that injects the droplets between the electrodes, as is described for example in Proceedings of SPIE—Volume 6517 Emerging Lithographic Technologies XI, Michael J. Lercel, Editor, 65170P (Mar. 15, 2007).

According to an embodiment of the invention, there is provided a device constructed and arranged to generate radiation by using an electrical discharge through a gaseous medium. The device includes a first electrode and a second electrode, and a liquid supply arranged to provide a liquid to a location in the device. The device is arranged to be electrically supplied with a voltage and to supply the voltage at least partially to the first electrode and the second electrode in order to allow the electrical discharge to be generated in an electrical field created by the voltage. The electrical discharge produces a radiating plasma. The device also includes a shield arranged between the discharge location and a conducting part connected to the first electrode and/or the second electrode.

The device may include an actuator constructed and arranged to move the first electrode and/or the second electrode. Additionally, the liquid supply may be a liquid bath and the actuator may move the first electrode and/or the second electrode through the bath. The liquid may include at least one of tin, gallium, indium and lithium. The first electrode and/or the second electrode may be formed by a moving cable.

In an embodiment, the first electrode and/or the second electrode is formed by a rotatable disk.

According to another aspect, a lithographic apparatus is provided, the lithographic apparatus including the aforementioned device. Typically, the lithographic apparatus may also include a support configured to support a patterning device, the patterning device being configured to impart the beam of radiation with a pattern in its cross-section, a substrate table configured to hold a substrate, and a projection system configured to project the patterned beam onto a target portion of the substrate.

According to an aspect, a lithographic apparatus is provided. The lithographic apparatus comprises a device that is constructed and arranged to generate radiation by using a discharge through a gaseous medium, the device comprising: liquid; first and second electrodes; a liquid supply arranged to provide a liquid at one or more locations in the device; and an actuator constructed and arranged to move at least one of said first and second electrodes; wherein the device is arranged to be electrically supplied with a voltage and to supply the voltage at least partially to the first and second electrodes in order to allow the electrical discharge to be generated in an electrical field created by the voltage, the electrical discharge producing a radiating plasma.

The lithographic apparatus may further comprise an illumination system configured to condition a beam of radiation from the radiation generator; a support configured to supporting a patterning device, the patterning device being configured to impart the beam of radiation with a pattern in its cross-section; a substrate table configured to hold a substrate; and a projection system configured to project the patterned beam onto a target portion of the substrate, wherein the device further comprises a shield that is arranged between the discharge location and a conducting part connected to at least one of said electrodes. The liquid supply may be arranged to provide the liquid at one or more locations on the electrodes. The liquid supply may be arranged to provide the liquid at a location between the electrodes. In the latter case, the liquid supply may be a liquid injector that injects the liquid as droplets between the electrodes.

According to an embodiment, there is provided a lithographic apparatus that includes a device constructed and arranged to generate radiation. The device includes a first electrode and a second electrode, and a liquid supply arranged to provide a liquid to a location in the device. The device is arranged to be electrically supplied with a voltage and to supply the voltage at least partially to the first electrode and the second electrode in order to allow the electrical discharge to be generated in an electrical field created by the voltage. The electrical discharge produces a radiating plasma. The device also includes a shield arranged between the discharge location and a conducting part connected to the first electrode and/or the second electrode. The lithographic apparatus also includes a support configured to support a patterning device, the patterning device being configured to impart the beam of radiation with a pattern in its cross-section, a substrate table configured to hold a substrate, and a projection system configured to project the patterned beam onto a target portion of the substrate.

The device may further comprise an ignition source configured to at least partially evaporate the liquid to form said gaseous medium in order to trigger the radiating plasma from the liquid provided by the liquid supply resulting in the electrical discharge.

According to an aspect, a device manufacturing method is provided. The method comprises supplying a liquid to a first electrode and/or a second electrode; applying a voltage to the first electrode and the second electrode to generate a discharge through a gaseous medium at a discharge location in an electrical field created by the voltage; providing a shield arranged between the discharge location and a conducting part connected to at least one of the electrodes; patterning the beam of radiation with a pattern in its cross-section; and projecting the patterned beam of radiation onto a target portion of a substrate.

During operation, the substance moving from the environment of the discharge location towards the conducting part is collected by the shield that is arranged between the discharge location and the conducting part. Therewith it may be prevented that the substance collects at the conducting part and could form a short circuit with a conducting part connected to the other electrode. Note that it would not generally be possible to prevent these short circuits simply by putting a slab of insulating material between the conducting part and the conducting part connected to the other electrode, since the substance would deposit on the slab and make it conductive during the course of operation.

### BRIEF DESCRIPTION OF THE DRAWINGS

These and other aspects are described in more detail with reference to the drawing. Therein:

FIG. 1 schematically shows a lithographic apparatus according to an embodiment of the invention;

FIG. 2A shows a side view of a prior art device constructed and arranged to generate radiation;

FIG. 2B schematically shows a top-view of this device according to B in FIG. 2A;

FIG. 3A schematically shows a side-view of an embodiment of a device according to the invention;

FIG. 3B schematically shows a top-view of the embodiment according to B in FIG. 3A;

FIG. 4 schematically shows an embodiment of the device;

FIG. 5 schematically shows an embodiment of the device; and

FIG. 6 schematically shows an embodiment of the device.

### DETAILED DESCRIPTION

In the following detailed description numerous specific details are set forth in order to provide a thorough understanding of the present invention. However, it will be understood by one skilled in the art that the present invention may be practiced without these specific details. In other instances, well-known methods, procedures, and components have not been described in detail so as not to obscure aspects of the present invention. This invention may, however, be embodied in many different forms and should not be construed as limited to the embodiments set forth herein. Rather, these embodiments are provided so that this disclosure will be thorough and complete. In the drawings, the size and relative sizes of layers and regions may be exaggerated for clarity.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

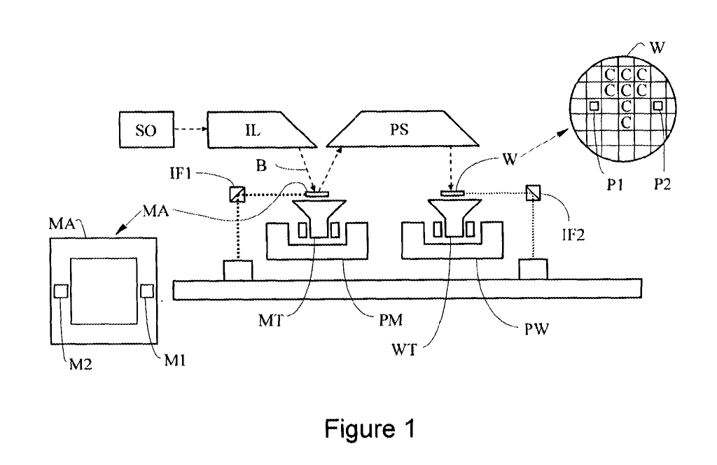

FIG. 1 schematically depicts a lithographic apparatus according to one embodiment of the invention. The apparatus comprises an illumination system (illuminator) IL configured to condition a radiation beam B (e.g. UV radiation or EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive or reflective projection lens system) PS configured to project a pattern imparted to the radiation beam B by patterning device MA onto a target portion C (e.g. comprising one or more dies) of the substrate W.

The illumination and projection system may include various types of optical components, such as refractive, reflective, diffractive or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, or any combination thereof, as appropriate for the exposure radiation being used. Any use of the term “projection lens” herein may be considered as synonymous with the more general term “projection system”.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus, for example when the source is a mercury lamp. The illuminator IL may comprise an adjuster for adjusting the angular intensity distribution of the radiation beam. Generally, at least the outer and/or inner radial extent (commonly referred to as s-outer and s-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Referring to the radiation source SO in FIG. 1, a typical (tin-based) plasma discharge sources consists of two slowly rotating wheels on which liquid tin is continuously applied, e.g. by partly immersing them in a liquid tin bath as discussed in Pankert et al. cited above. The wheels act as electrodes and a discharge is established at the point where the wheels are closest to one another. Instead of an Tin based plasma source, several other fuel sources may be used to generate EUV radiation at a wavelength of 13.5 nm, including xenon, and lithium. Tin is often preferred for production tool specifications because of its high conversion efficiency.

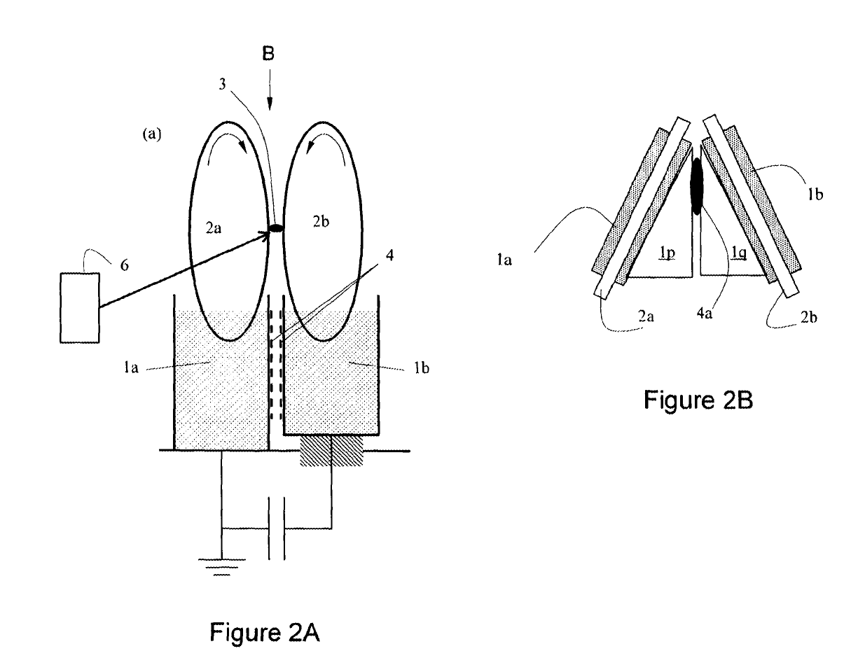

FIG. 2A and 2B show such a known radiation source, e.g. a tin-based EUV source with rotating disk electrodes. The prior art source comprises two liquid baths 1a and 1b through which respective electrodes 2a and 2b are rotated. In this example, each of the baths 1a, 1b contains liquid tin, and therefore may be called liquid tin baths. The baths 1a, 1b are thermally coupled to respective heating elements arranged in housings 1p, 1q. The heating elements serve to melt the tin at start-up of the device. During normal operation of the device the heating elements are switched off and the housings 1p, 1q serve to conduct heat from the baths 1a, 1b to a heat sink. One bath 1a is connected to electrical ground, the other bath 1b is at high voltage. During normal operation of the source, tin is evaporated from one of the electrodes by a pulsed trigger laser 6 and the discharge is subsequently established through the tin vapor at discharge location 3. About 2 μg of tin may be evaporated in each pulse, which corresponds to 10 mg/s or 36 g/h at a typical repetition rate of 5 kHz. Tin debris may be emitted from different positions along the discharge: micro particles originate mainly at the electrode surface, while most of the atomic and ionic debris comes from the pinch (between the electrodes). In particular the parts of the source that are close to the discharge receive a relatively large amount of debris. Consequently, areas 4 on the sides of the baths 1 may be quickly contaminated with tin 4a, and may eventually build up to cause a short circuit.

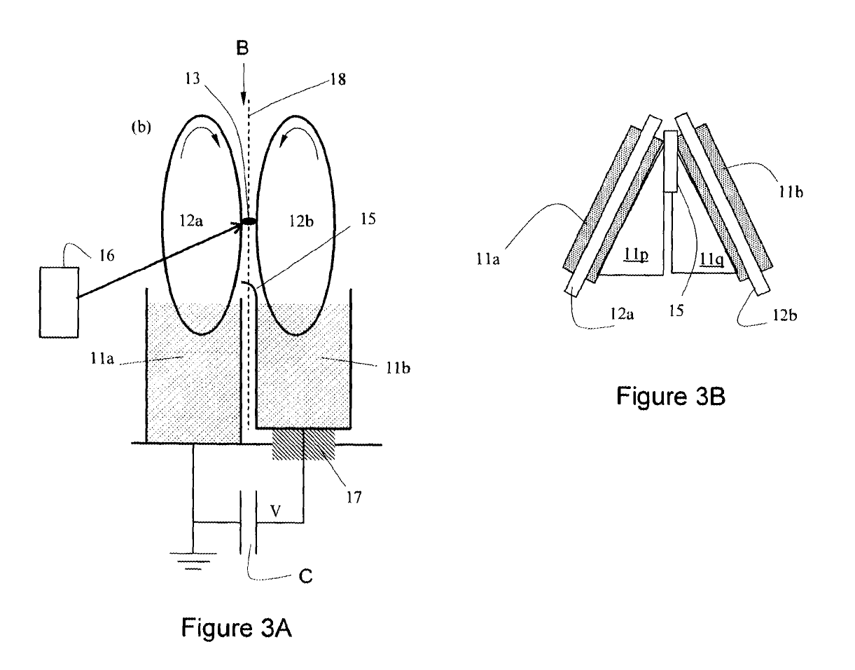

FIG. 3A and 3B show an embodiment of a device constructed and arranged to generate radiation. Parts therein corresponding to those in FIGS. 2A and 2B, have a reference numeral that is 10 higher. In the embodiment shown in FIGS. 2A and 2B, the device comprises a liquid bath 11b as well as a further liquid bath 11a. The baths 11a, 11b are coupled via respective conductors to a capacitor bank C that provides a voltage V. The conductor towards bath 11b is isolated with isolator 17. The device comprises first and second electrodes 12a, 12b that may be arranged in the respective liquid baths 12a, 12b. The first and second electrodes 12a, 12b are moved by a respective actuator (not shown) between the liquid and a volume above the liquid. In the embodiment shown, the electrodes 12a, 12b are disks that are rotated partly through the liquid in the baths 11a, 11b. The liquid may comprise tin. However, other liquids, like gallium, indium, lithium or any combination thereof may be used instead of or in addition to tin.

In an embodiment, the device may have only one electrode that rotates in a liquid bath, while another electrode may be arranged statically. In that case, the rotating electrode carries the liquid from the bath towards the discharge location 13. The statically arranged electrode may, however, wear relatively fast during operation due to the discharge striking at its surface. Both electrodes 12a, 12b may be implemented as rotating in a liquid bath, since in that case the discharge strikes at the liquid carried along at the surface of the electrode from the liquid bath. Furthermore, the rotation of the electrodes 12a, 12b through the liquid baths 11a, 11b provides for a cooling of the electrodes 12a, 12b. Typically the tin bath will be cooler (for example: below 300° C.) than the electrode (typically up to 800° C.) and may therefore provide substantial cooling by conduction.

An ignition source 16 is configured to trigger a discharge-produced radiating plasma from liquid adherent to the electrode, by a discharge at a discharge location 13 in a gap between the first electrode and the second electrode. The gap has a width of approximately 3 mm. The ignition source 16 may, for example, be configured to generate a beam of laser radiation but may alternatively generate an electron beam.

The device may further comprise a shield 15 that is arranged between the discharge location and a conducting part, the bath 11a connected to at least one of said electrodes 12a. The shield 15 blocks a direct line-of-sight from the discharge location 13 to a gap between a conducting part 11p connected to the first electrode 12a and a conducting part 11q connected to the second electrode 12b. The shield 15 may be arranged such that any gap between a conducting part which is electrically connected to the first electrode and a conducting part which is electrically connected to the second electrode is not visible from the discharge location 13. However, in practice it may be sufficient that the shield 15 only covers relatively narrow gaps, and/or gaps that are close to the discharge location. Such gaps may be wholly or partially covered. If the conducting part is separated by a large distance, for example, more than 3 mm, from an other conducting part, the risk that condensing droplets form a short circuiting bridge between the conducting parts may be reduced. The risk may be further minimized if the shield also covers any mutually different conducting parts separated at a distance up to 5 mm or even up to 1 cm. If a conducting part is separated for example by more than 2 cm from the discharge location, the amount of liquid that is deposited may be considered so small that it will not or is at least unlikely to result into a short circuit on a short term.

In the embodiment shown, the shield 15 is tilted in a direction towards the liquid bath 11b so that droplets of the liquid formed at the shield 15 flow into the liquid bath 11b.

The shield 15 may be a separate part. The shield may be manufactured from an arbitrary material that is sufficiently heat resistant, e.g. of a ceramic material or of a refractory metal.

In the embodiment shown, the shield 15 is provided as an integral part of the liquid bath 11b. This may have an advantage of a good heat contact between the shield 15 and the liquid bath 11b, so that the heat caused by the radiation directed towards the shield 15 may be easily conducted away. This embodiment illustrates that the shield need not be a separate part but may be an integral part of one of the conducting parts connected to either electrode, in this case the liquid bath. Thus, by designing the source geometry such that a conducting part in itself covers a gap as described above, the source may be protected against short circuits by way of application of embodiments of the invention.

In FIGS. 3A and 3B, it can be seen that the shield 15 extends through an imaginary plane 18 between the liquid baths 11a, 11b. This way, it is prevented in particular that the liquid originating from the discharge location 13 approaches the space between the baths 11a, 11b, and would consequently cause a short circuit between the baths 11a, 11b.

Typical parameters for the trigger laser may include an energy per pulse Q of approximately 10-100 mJ for a tin discharge and approximately 1-10 mJ for a lithium discharge, a duration of the pulse of τ=about 1-100 ns, a laser wavelength of λ=about 0.2-10 μm, a frequency of about 5-100 kHz. The laser source 16 may produce a laser beam directed to the electrode 12b to ignite the adherent liquid from liquid bath 11b.

Thereby, liquid material on the electrode 12b may be evaporated and pre-ionized at a well-defined location 13, i.e. the location where the laser beam hits the electrode 12b. From that location, a discharge towards the electrode 12a may develop. The precise location 13 of the discharge can be controlled by the laser 16. This is desirable for the stability, i.e. homogeneity, of the device constructed and arranged to generate radiation and may have an influence on the constancy of the radiation power of the device. This discharge generates a current between the electrodes 12a, 12b. The current induces a magnetic field. The magnetic field generates a pinch, or compression, in which ions and free electrons are produced by collisions. Some electrons will drop to a lower band than the conduction band of atoms in the pinch and thus produce radiation. When the liquid material is chosen from gallium, tin, indium or lithium or any combination thereof, the radiation includes large amounts of EUV radiation. The radiation emanates in all directions and may be collected by a radiation collector in the illuminator IL of FIG. 1. The laser 16 may provide a pulsed laser beam.

The radiation is isotropic at least at angles to a Z-axis with an angle θ=about 45-105° . The Z-axis refers to the axis aligned with the pinch and going through the electrodes 12a, 12b and the angle θ is the angle with respect to the Z-axis. The radiation may be isotropic at other angles as well.

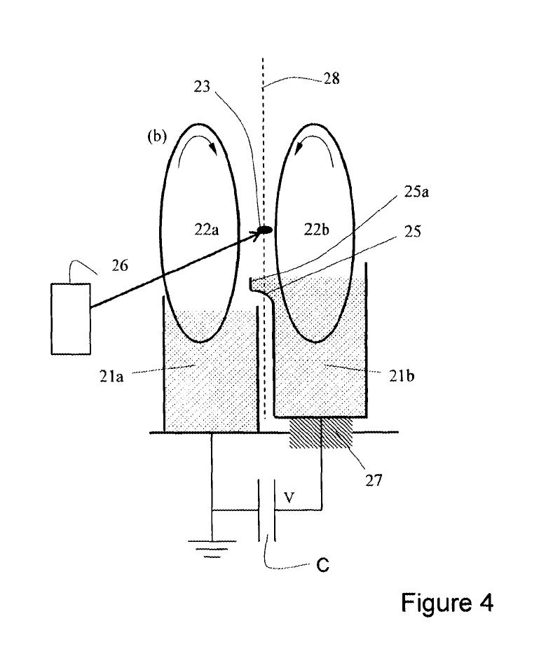

FIG. 4 shows an embodiment of the device. Parts therein corresponding to those in FIGS. 3A and 3B have a reference number that is 10 higher. As shown therein, the liquid level in bath 21b extends over a shield 25. The shield 25 has an upstanding rim 25a. In this embodiment, it is not necessary that the shield 25 be tilted towards the bath 21b to achieve that the liquid returns to the bath 21b.

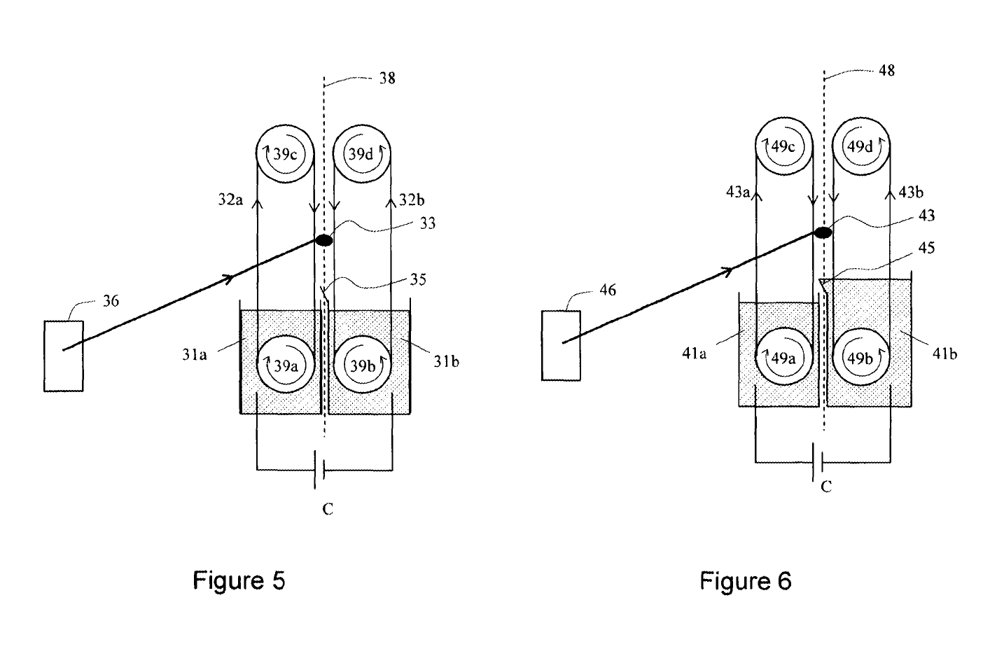

FIG. 5 shows an embodiment, wherein at least one electrode 32b is formed by a moving cable. Parts therein corresponding to those in FIG. 4 have a reference number that is 10 higher. In this embodiment, both electrodes 32a, 32b are formed by moving cables that are circulated through a respective liquid bath 31a, 31b, which has the advantage that both electrodes are protected against wear by the discharge, and that both electrodes are efficiently cooled.

In this embodiment two baths of liquid, in particular, liquid tin 31a, 31b are shown to be electrically insulated from one another. A high voltage is applied across the baths by a capacitor bank/charger C. Through the baths, closed cable loops 32a, 32b run on reels—one suspended above the bath (represented by 39c and 39d) and one fully immersed in the bath (represented by 39a and 39b). It may be feasible to provide a single cable electrode in conjunction with a fixed electrode or a slowly revolving conventional electrode as explained hereabove with respect to the Pankert et al. publication, in particular, when the plasma is created in the vicinity of the cable. In the illustrated embodiment, liquid tin can adhere to one or both cables as they emerge from the baths. At a position where both cables are separated by typically a few millimeters, tin may be evaporated from one of the cables by a beam generated by a laser 36. The laser beam functions as ignition source configured to trigger a discharge produced radiating plasma from liquid adherent to the electrode, by a discharge between the two cables. A discharge is subsequently established through the tin vapor, resulting in a tin plasma at discharge location 33 that emits EUV radiation. The cable 32a, 32b may be wound around the lower reel 39a, 39b an arbitrary number of times to provide the required cooling effect. Alternatively, a number of reels (not shown) may be immersed in the liquid to guide the cable through the liquid across a predetermined distance. Typically, the distance is predetermined in conjunction with a typical cable speed, in order to allow the cable sufficiently long immersed in the liquid to provide proper cooling. Motion of the cables is achieved by rotating either the lower or the upper reels via an external rotation mechanism.

In particular, the cables can be moved so that the cable parts that are facing each other both move into the liquid baths 31a and 31b. Alternatively, motion of these parts can be inversed to move the cable out of said liquid bath. Combinations of up and downwards velocity directions are feasible. An advantage of a downward direction is the immediate cooling of the cable through the liquid a. An advantage of an upward direction may be an improved adherence of the liquid to the cable 32a, 32b. The tilted shield 35 collects liquid released in this process and allows the collected liquid to flow back into the bath 31b.

In order that a self-inductance is in a range of less than about 15 nH, the pinch may be located fairly close (˜10 mm) to the liquid surface in order to give an acceptable self-inductance: for a loop of 5×10 mm with a wire radius of 0.4 mm, an inductance can be calculated to be L=12.3 nH. Increasing the wire radius may reduce the self-inductance. For example, a 1 mm wire will have L=6.8 nH.

FIG. 6 shows an embodiment of a radiation source that also uses cables 43a, 43b as electrodes. Parts therein corresponding to those in FIG. 5 have a reference number that is 10 higher. As compared to the embodiment shown in FIG. 5, the shield 45 is integral with one of the liquid baths 41b, and the liquid level in that bath 41b extends over the shield 45.

While FIGS. 5 and 6 show examples of molybdenum as cable material, other types of materials may be used. In particular, fibers or fiber-reinforced materials can undergo very high (anisotropic) elastic strains provided they have sufficient thermal stability. Also, in view of relative high temperatures, refractory metals such as molybdenum or tungsten may be considered. In practice, one may use a cable consisting of braided metal wires, which may reduce the overall bending strain in the cable. In an embodiment, rather than deform the cable, the cable may be replaced with a chain consisting of metal links. A typical dimension of the cable diameter may range between about 0.1 and 2 mm.

The cables 43a, 43b may have a circular cross-section of 0.1.-2 mm diameter. In addition, it may be desirable to employ one or both cables 43a, 43b with a flat surface, for example in the form of a ribbon.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

In the claims the word “comprising” does not exclude other elements or steps, and the indefinite article “a” or “an” does not exclude a plurality. A single component or other unit may fulfill the functions of several items recited in the claims. The mere fact that certain measures are recited in mutually different claims does not indicate that a combination of these measures cannot be used to advantage. Any reference signs in the claims should not be construed as limiting the scope.

1. A device constructed and arranged to generate radiation by using an electrical discharge through a gaseous medium, the device comprising:
a first electrode and a second electrode;
a liquid supply arranged to provide a liquid to a location in the device;
the device being arranged to be electrically supplied with a voltage and to supply the voltage at least partially to the first electrode and the second electrode in order to allow the electrical discharge to be generated in an electrical field created by the voltage, the electrical discharge producing a radiating plasma; and
a shield arranged between the discharge location and a conducting part connected to the first electrode and/or the second electrode:

2. A device according to claim 1, further comprising an actuator constructed and arranged to move the first electrode and/or the second electrode and wherein the liquid supply is a liquid bath and the actuator moves the first electrode and/or the second electrode through the bath.

3. A device according to claim 2, wherein the shield is tilted in a direction towards the liquid bath.

4. A device according to claim 2, wherein the shield is provided as an integral part of the bath.

5. A device according to claim 2, wherein a liquid level in the bath extends over the shield.

6. A device according to claim 2, further comprising a second liquid bath, wherein the shield extends through an imaginary plane between the liquid baths.

7. A device according to claim 1, further comprising an ignition source configured to at least partially evaporate the liquid to form said gaseous medium in order to trigger the radiating plasma from the liquid provided by the liquid supply resulting in the electrical discharge.

8. A device according to claim 7, wherein the ignition source is configured to generate a beam of laser radiation and/or an electron beam to trigger the discharge.

9. A device according to claim 1, wherein the shield is arranged to block a gap between a conducting part electrically connected to the first electrode and a conducting part electrically connected to the second electrode from the discharge location.

10. A device according to claim 1, wherein the liquid supply comprises a liquid injector configured to inject the liquid as droplets between the first electrode and the second electrode.

11. (canceled)

12. A device manufacturing method, comprising:
supplying a liquid to a first electrode and/or a second electrode;
applying a voltage to the first electrode and the second electrode to generate a discharge through a gaseous medium at a discharge location in an electrical field created by the voltage;
providing a shield arranged between the discharge location and a conducting part connected to at least one of said electrodes;
patterning the beam of radiation with a pattern in its cross-section; and
projecting the patterned beam of radiation onto a target portion of a substrate.

13. A method according to claim 12, further comprising:
at least partially evaporating the liquid to form a gaseous medium in order to trigger a discharge-produced radiating plasma from the liquid.

14. A method according to claim 12, further comprising:
supplying the liquid to the first electrode and/or second electrode by moving the first electrode and/or second electrode through a liquid bath.

15. A lithographic apparatus, comprising:
a device constructed and arranged to generate radiation, the device comprising
a first electrode and a second electrode,
a liquid supply arranged to provide a liquid to a location in the device,
the device being arranged to be electrically supplied with a voltage and to supply the voltage at least partially to the first electrode and the second electrode in order to allow the electrical discharge to be generated in an electrical field created by the voltage, the electrical discharge producing a radiating plasma, and
a shield arranged between the discharge location and a conducting part connected to the first electrode and/or the second electrode;
a support configured to support a patterning device, the patterning device being configured to impart the beam of radiation with a pattern in its cross-section;
a substrate table configured to hold a substrate; and
a projection system configured to project the patterned beam onto a target portion of the substrate.
